(19) United States
(12) Patent Application Publication
(10) Pub. No.: US 2024/0420712 A1
(43) Pub. Date: Dec. 19, 2024

(54) METHOD OF ENCODING/DECODING AUDIO SIGNAL AND DEVICE FOR PERFORMING THE SAME

(71) Applicant: Electronics and Telecommunications Research Institute, Daejeon (KR)

(72) Inventors: Byeongho CHO, Daejeon (KR); Seung Kwon BEACK, Daejeon (KR); Jung Won KANG, Daejeon (KR); Soo Young PARK, Daejeon (KR); Jongmo SUNG, Daejeon (KR); Tae Jin LEE, Daejeon (KR); Woo-taek LIM, Daejeon (KR); Inseon JANG, Daejeon (KR)

(73) Assignee: Electronics and Telecommunications Research Institute, Daejeon (KR)

(21) Appl. No.: 18/732,758

(22) Filed: Jun. 4, 2024

(30) Foreign Application Priority Data
Jun. 19, 2023 (KR) 10-2023-0077881
Dec. 12, 2023 (KR) 10-2023-0179940

(51) Int. Cl. G10L 19/028; G10L 19/02; G10L 19/035; G10L 19/06

(52) U.S. Cl. CPC G10L 19/028; G10L 19/0204; G10L 19/035; G10L 19/06

(57) ABSTRACT

A method of encoding/decoding an audio signal and a device for performing the same are provided. The method of encoding an audio signal includes generating, based on the audio signal, a linear prediction coding (LPC) bitstream and a frequency-domain signal of the audio signal, generating, based on the LPC bitstream and the frequency-domain signal, a first residual signal including information on a frequency envelope of the frequency-domain signal, and outputting a second residual signal by processing a first residual signal through one of a plurality of signal processing paths.

### CROSS-REFERENCE TO RELATED APPLICATION

This application claims the benefit of Korean Patent Application No. 10-2023-0077881 filed on Jun. 19, 2023 and 10-2023-0179940 filed on Dec. 12, 2023, in the Korean Intellectual Property Office, the entire disclosures of which are incorporated herein by reference for all purposes.

### BACKGROUND

### 1. Field of the Invention

One or more embodiments relate to a method of encoding/decoding an audio signal and a device for performing the same.

### 2. Description of the Related Art

In the audio coding techniques field, research on techniques that integrate transform-based coding and linear predictive coding has been conducted. Transform-based codecs include discrete Fourier transform (DFT), modulated discrete cosine transform (MDCT), a modulated complex lapped transform (MCLT), and the like.

An MCLT is an example of a lapping transform used in audio coding. Lapping transform divides an audio signal into blocks but uses an overlap window that extends beyond the boundaries of the blocks. The use of an overlap window may smooth a transition between the blocks of the audio signal, thereby reducing artifacts and improving audio quality.

In the transform-based coding, pre-echo may be caused by the spread of quantization noise. Quantization noise may be noise generated in the process of reducing the number of bits by quantizing a converted coefficient after analyzing a frequency. Pre-echo is also called a forward echo and may refer to a digital audio compression artifact in which sound is heard before the sound occurs.

Time noise shaping (TNS) was first proposed to address pre-echo when performing transform-based coding on an excitation signal using a time frame of a large size. Coding technology that uses TNS performs TNS on an MDCT coefficient and may thus cause time domain aliasing (TDA). Attempts have been made to resolve the issue of causing TDA by using a window with less overlap or by window switching.

The above description has been possessed or acquired by the inventor(s) in the course of conceiving the present disclosure and is not necessarily an art publicly known before the present application is filed.

### SUMMARY

Embodiments provide technology that performs frequency domain noise shaping (FDNS) on a frequency-domain signal generated through a modulated complex lapped transform (MCLT) and selectively performs complex temporal noise shaping (CTNS) on audio signal based on a prediction gain of the signal on which FDNS has been performed.

However, the technical aspects are not limited to the aforementioned aspects, and other technical aspects may be present.

According to an aspect, there is provided a method of encoding an audio signal including generating, based on the audio signal, a linear predictive coding (LPC) bitstream and a frequency-domain signal of the audio signal, generating, based on the LPC bitstream and the frequency-domain signal, a first residual signal including information on a frequency envelope of the frequency-domain signal, and outputting a second residual signal by processing a first residual signal through one of a plurality of signal processing paths. The plurality of signal processing paths may include a first signal processing path that comprises a noise shaping operation and a second signal processing path that does not comprise the noise shaping operation.

The outputting of the second residual signal may include selecting one of the plurality of signal processing paths based on a prediction gain of the first residual signal.

The selecting of one of the plurality of signal processing paths may include selecting the first signal processing path when the prediction gain of the first residual signal is greater than or equal to a preset threshold value and selecting the second signal processing path when the prediction gain of the first residual signal is less than the preset threshold value.

The outputting of the second residual signal may further include outputting flag information indicating whether the noise shaping operation has been performed, based on a type of a signal processing path, among the plurality of signal processing paths, through which the first residual signal is processed.

The first signal processing path may be a path through which to output a complex-LPC (C-LPC) bitstream based on the first residual signal and to output a signal, which is obtained by removing noise from the first residual signal through the noise shaping operation, as the second residual signal, based on the C-LPC bitstream.

The second signal processing path may be a path through which to output a real part of the first residual signal as the second residual signal.

The outputting of the second residual signal may further include outputting a scale factor for quantizing the second residual signal for each sub-band and outputting, based on the scale factor and the second residual signal, a quantization bitstream obtained by quantizing the second residual signal.

According to another aspect, there is provided a method of decoding an audio signal including generating a second residual signal based on a quantization bitstream obtained by quantizing the second residual signal and a scale factor for quantizing the second residual signal for each sub-band and outputting a first residual signal by processing the second residual signal through one of a plurality of signal restoration paths.

The plurality of signal restoration paths may include a first signal restoration path that includes an inverse noise shaping operation and a second signal restoration path that does not include the inverse noise shaping operation.

The outputting of the first residual signal may include selecting one of the plurality of signal restoration paths based on flag information that indicates whether a noise shaping operation has been performed.

The outputting of the first residual signal may include, when the first signal restoration path is selected, outputting a signal, in which noise is synthesized with the second residual signal through the inverse noise shaping operation, as a first residual signal, based on the second residual signal and a C-LPC bitstream.

The outputting of the first residual signal may include, when the second signal restoration path is selected, outputting the second residual signal as the first residual signal.

The outputting of the first residual signal may further include restoring the audio signal based on an LPC bitstream and the first residual signal.

The restoring of the audio signal may include outputting a frequency-domain signal of the audio signal based on the LPC bitstream and the first residual signal and outputting a time-domain signal of the audio signal based on the frequency-domain signal and the flag information.

The outputting of the time-domain signal of the audio signal may include removing time-domain aliasing (TDA) of the audio signal based on the frequency-domain signal and the flag information.

According to another aspect, there is provided a device for encoding an audio signal including a processor and a memory configured to store instructions. The instructions may, when executed by the processor, cause the device to generate, based on the audio signal, an LPC bitstream and a frequency-domain signal of the audio signal, generate, based on the LPC bitstream and the frequency-domain signal, a first residual signal comprising information on a frequency envelope of the frequency-domain signal, and output a second residual signal by processing the first residual signal through one of a plurality of signal processing paths. The plurality of signal processing paths may include a first signal processing path that comprises a noise shaping operation and a second signal processing path that does not comprise the noise shaping operation.

The instructions may, when executed by the processor, cause the device to select one of the plurality of signal processing paths based on a prediction gain of the first residual signal.

The instructions may, when executed by the processor, cause the device to output flag information indicating whether the noise shaping operation has been performed, based on a type of a signal processing path, among the plurality of signal processing paths, through which the first residual signal is processed.

The first signal processing path may be a path through which to output a C-LPC bitstream based on the first residual signal and to output a signal, which is obtained by removing noise from the first residual signal through the noise shaping operation, as the second residual signal, based on the C-LPC bitstream.

The second signal processing path may be a path through which to output a real part of the first residual signal as the second residual signal.

The instructions may, when executed by the processor, cause the device to output a scale factor for quantizing the second residual signal for each sub-band and to output, based on the scale factor and the second residual signal, a quantization bitstream obtained by quantizing the second residual signal.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an example of an encoder and a decoder, according to an embodiment;

FIG. 2 is a diagram illustrating an example of the encoder shown in FIG. 1;

FIG. 3 is a diagram illustrating an example of the decoder shown in FIG. 1;

FIG. 4 is a flowchart of an encoding method according to an embodiment;

FIG. 5 is a flowchart of a decoding method according to an embodiment; and

FIG. 6 is a diagram illustrating an example of a device, according to an embodiment.

### DETAILED DESCRIPTION

The following structural or functional description of examples is provided as an example only and various alterations and modifications may be made to the examples. Thus, an actual form of implementation is not construed as limited to the examples described herein and should be understood to include all changes, equivalents, and replacements within the idea and the technical scope of the disclosure.

Although terms such as first, second, and the like are used to describe various components, the components are not limited to the terms. These terms should be used only to distinguish one component from another component. For example, a “first” component may be referred to as a “second” component, and similarly, the “second” component may also be referred to as the “first” component.

It should be noted that when one component is described as being “connected,” “coupled,” or “joined” to another component, the first component may be directly connected, coupled, or joined to the second component, or a third component may be “connected,” “coupled,” or “joined” between the first and second components.

The singular forms “a,” “an,” and “the” are intended to include the plural forms as well, unless the context clearly indicates otherwise. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical and scientific terms have the same meanings as those commonly understood by one of ordinary skill in the art to which this disclosure pertains. Terms such as those defined in commonly used dictionaries are to be interpreted as having a meaning that is consistent with their meaning in the context of the relevant art and are not to be interpreted in an idealized or overly formal sense unless expressly so defined herein.

Hereinafter, the examples are described in detail with reference to the accompanying drawings. When describing the examples with reference to the accompanying drawings, like reference numerals refer to like components and a repeated description related thereto is omitted.

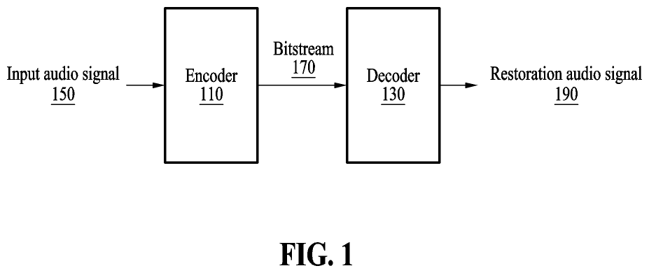

FIG. 1 is a diagram illustrating an example of an encoder and a decoder, according to an embodiment.

Referring to FIG. 1, an audio signal encoding/decoding device may include an encoder 110 and/or a decoder 130. An input audio signal 150 and a restoration audio signal 190 may be signals in a time domain.

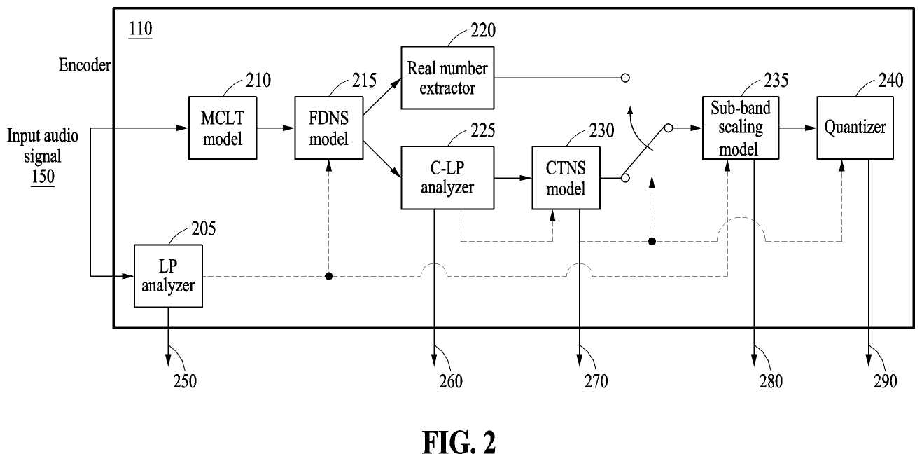

The encoder 110 may encode the input audio signal 150 to generate a bitstream 170 and may transmit (or output) the bitstream 170 to the decoder 130. The encoder 110 is described in detail with reference to FIG. 2.

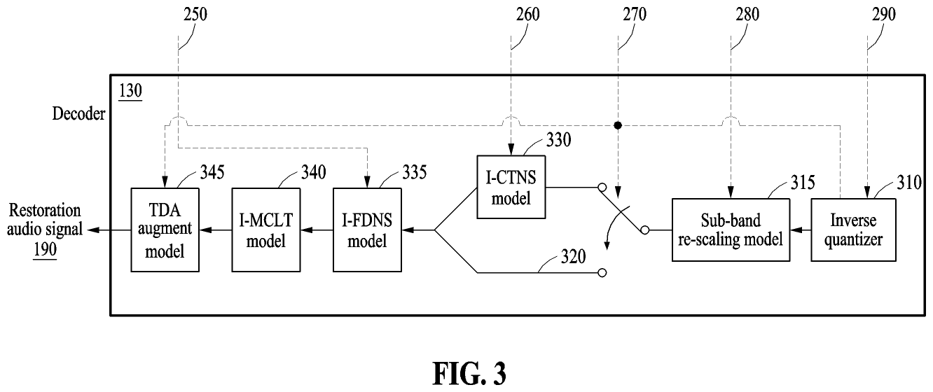

The decoder 130 may decode the bitstream 170 obtained (or received) from the encoder 110 to generate the restoration audio signal 190. The decoder 130 is described in detail with reference to FIG. 3.

FIG. 2 is a diagram illustrating an example of the encoder 110 shown in FIG. 1.

Referring to FIG. 2, the encoder 110 may include a linear prediction (LP) analyzer 205, an MCLT model 210, a frequency domain noise shaping (FDNS) model 215, a real number extractor 220, a complex-linear prediction (C-LP) analyzer 225, a complex temporal noise shaping (CTNS) model 230, a sub-band scaling model 235, and a quantizer 240.

The LP analyzer 205 may generate a linear prediction coding (LPC) bitstream based on the input audio signal 150. For example, the LP analyzer 205 may generate the LPC bitstream by performing a linear predictive analysis on the input audio signal 150.

The LP analyzer 205 may transmit the LPC bitstream to the FDNS model 215.

The MCLT model 210 may, based on the input audio signal 150, generate a frequency-domain signal of the input audio signal 150. For example, the MCLT model 210 may perform an MCLT on the input audio signal 150 through a window function. The MCLT model 210 may classify the input audio signal 150 in a time domain into one or more blocks (or sections) through the window function. The window function may be defined so that generated blocks may overlap by exactly 50%. The MCLT model 210 may generate the frequency-domain signal by performing an MCLT for each of the classified blocks.

The FDNS model 215 may obtain (e.g., receive) the frequency-domain signal generated by the MCLT model 210 from the MCLT model 210 and/or an LPC bitstream from the LP analyzer 205. The FDNS model 215 may generate a first residual signal based on the frequency-domain signal and the LPC bitstream. The FDNS model 215 may perform frequency-domain noise shaping on the frequency domain signal. The first residual signal may include information on a frequency envelope of the frequency-domain signal. For example, the FDNS model 215 may extract the frequency envelope of the frequency-domain signal based on the LPC bitstream. The FDNS model 215 may generate the first residual signal by subtracting a magnitude of the frequency-domain signal from the frequency envelope.

The first residual signal may be processed through one of a plurality of signal processing paths. The FDNS model 215 may select one of the plurality of signal processing paths based on a prediction gain of the first residual signal. For example, the FDNS model 215 may determine whether the prediction gain of the first residual signal is greater than or equal to a preset threshold value. The FDNS model 215 may select a first signal processing path when the prediction gain of the first residual signal is greater than or equal to the preset threshold value and may select a second signal processing path when the prediction gain of the first residual signal is less than the preset threshold value.

The first signal processing path may be performed by the C-LP analyzer 225 and the CTNS model 230. When the first signal processing path is selected, the FDNS model 215 may transmit (or send) the first residual signal to the C-LP analyzer 225.

The C-LP analyzer 225 may obtain the first residual signal from the FDNS model 215. The C-LP analyzer 225 may output a complex linear prediction coefficient (C-LPC) bitstream based on the first residual signal. For example, the C-LP analyzer 225 may perform a complex a linear predictive analysis on the first residual signal to generate the C-LPC bitstream. The C-LP analyzer 225 may output the C-LPC bitstream to the CTNS model 230.

The CTNS model 230 may obtain (e.g., receive) the C-LPC bitstream from the C-LP analyzer 225. The CTNS model 230 may generate a second residual signal based on the C-LPC bitstream. The CTNS model 230 may perform noise shaping (e.g., temporal noise shaping) on the first residual signal based on the C-LPC bitstream. The second residual signal may include a signal obtained by performing noise shaping on the first residual signal. That is, the second residual signal may include a signal obtained by removing noise (e.g., noise in the time domain) from the first residual signal. For example, the CTNS model 230 may perform complex temporal noise shaping on the first residual signal based on the C-LPC bitstream. The second residual signal may include a signal obtained by performing complex temporal noise shaping on the first residual signal.

The CTNS model 230 may output flag information. The flag information may indicate whether a noise shaping operation (e.g., a temporal noise shaping operation) has been performed. A noise shaping operation related to the flag information may include only a noise shaping operation in the time domain. The flag information may be implemented to have one bit. A bit value of the flag information may indicate whether a noise shaping operation has been performed. For example, when the CTNS model 230 has not performed temporal noise shaping on the first residual signal, the CTNS model 230 may assign “0” to a bit value of the flag information. In another example, when the CTNS model 230 has performed temporal noise shaping on the first residual signal, the CTNS model 230 may assign “1” to the bit value of the flag information.

The second signal processing path may be performed by the real number extractor 220. When the second signal processing path is selected, the FDNS model 215 may transmit (or send) the first residual signal to the real number extractor 220.

The real number extractor 220 may obtain (e.g., receive) the first residual signal from the FDNS model 215. The real number extractor 220 may extract a real part of the first residual signal. The real number extractor 220 may output the real part of the first residual signal as the second residual signal.

That is, the second residual signal may be generated differently depending on a signal processing path (e.g., the first residual signal and the second residual signal).

The sub-band scaling model 235 may obtain the second residual signal from the CTNS model 230 and/or the real number extractor 220. For example, when the second residual signal is generated by the first signal processing path, the sub-band scaling model 235 may obtain the second residual signal from the CTNS model 230. When the second residual signal is generated by the second signal processing path, the sub-band scaling model 235 may obtain the second residual signal from the real number extractor 220.

The sub-band scaling model 235 may output a scale factor based on the second residual signal. The scale factor may include a factor for quantizing the second residual signal for each sub-band.

The sub-band scaling model 235 may obtain (e.g., calculate) the scale factor by a modified spectral quantization-gain (SQ_gain) function. The sub-band scaling model 235 may calculate scale factors of a plurality of sub-bands and adaptively determine allocated bits of the sub-bands. A method by which the sub-band scaling model 235 may calculate the allocated bits of the sub-bands is described in detail below with reference to Equations 1 to 5.

$$G ( v ) = 20 {log}_{10} \{ {\sum }_{f} H ( v , f ) \} / N \qquad [ Equation 1 ]$$

$$FER ( v , b ) \geq λ ( b ) - ( G ( v ) > 9.5 ? 0.025 : 0 ) \qquad [ Equation 2 ]$$

$${\overline{β}}_{a} ( b ) = {β}_{a} ( b ) \qquad [ Equation 3 ]$$

$${\overline{β}}_{a} ( b ) = 0 \qquad [ Equation 4 ]$$

$${β}_{t} ( v , b ) = {β}_{x} ( b ) + {\overline{β}}_{a} ( b ) \qquad [ Equation 5 ]$$

In Equations 1 to 5, v denotes an index of the sub-band, f denotes an index of a frequency, H(v, f) denotes a frequency envelope in a specific sub-band and a specific frequency, N denotes a total number of coefficients, G(v) denotes a gain of a v-th sub-band, βₓ(b) denotes a fixed bit allocated to the v-th sub-band, β_{α}(b) denotes an additional bit allocated to the v-th sub-band, βₜ(v, b) denotes a total allocated bits of the v-th sub-band, FER denotes a frequency envelope ratio, and λ(b) denotes a threshold value of FER.

When the inequation of Equation 2 is satisfied, the sub-band scaling model 235 may calculate the additional bit allocated to the sub-band as in Equation 3, and when the inequation of Equation 2 is not satisfied, the sub-band scaling model 235 may calculate the additional bit allocated to the sub-band as in Equation 4. When the additional bit allocated to the sub-band is calculated, the sub-band scaling model 235 may calculate the total allocated bits of the sub-band through Equation 5. That is, the sub-band scaling model 235 may adaptively calculate allocated bits for each sub-band.

The sub-band scaling model 235 may output the scale factor and/or the second residual signal to the quantizer 240.

The quantizer 240 may output a quantization bitstream based on the scale factor and the second residual signal. The quantization bitstream may include a signal into which the second residual signal is quantized. For example, the quantizer 240 may obtain the second residual signal classified into sub-bands by the scale factor. The quantizer 240 may quantize, for each sub-band, the second residual signal classified into sub-bands.

The encoder 110 may output the bitstream 170 to the decoder 130. The bitstream 170 may include information for decoding an audio signal encoded by the encoder 110. For example, an LP analyzer 205 may output an LPC bitstream to the decoder 130. The C-LP analyzer 225 may output the C-LPC bitstream to the decoder 130. The CTNS model 230 may output the flag information to the decoder 130. The sub-band scaling model 235 may output the scale factor to the decoder 130. The quantizer 240 may output the quantization bitstream to the decoder 130.

FIG. 3 is a diagram illustrating an example of the decoder 130 shown in FIG. 1.

Referring to FIG. 3, the decoder 130 may include an inverse quantizer 310, a sub-band re-scaling model 315, an inverse-CTNS (I-CTNS) model 330, an inverse-FDNS (I-FDNS) model 335, and inverse-MCLT (I-MCLT) model 340, and a time-domain aliasing (TDA) augment model 345.

The decoder 130 may obtain (e.g., receive) an LPC bitstream, a C-LPC bitstream, flag information, a scale factor, and a quantization bitstream from the encoder 110.

The inverse quantizer 310 may generate a second residual signal classified into sub-bands, based on the quantization bitstream. For example, the inverse quantizer 310 may generate the second residual signal classified into sub-bands by inverse-quantizing the quantization bitstream. The inverse quantizer 310 may output the second residual signal classified into sub-bands to the sub-band re-scaling model 315.

The sub-band re-scaling model 315 may generate a second residual signal based on the second residual signal classified into sub-bands and the scale factor. The sub-band re-scaling model 315 may calculate sections of sub-bands of the second residual signal classified into sub-bands, based on the scale factor. The sub-band re-scaling model 315 may generate the second residual signal by synthesizing the second residual signal classified into the calculated sections of sub-bands.

The sub-band re-scaling model 315 may select one of a plurality of signal restoration paths through which the second residual signal is processed. The sub-band re-scaling model 315 may select one of the plurality of signal restoration paths based on the flag information.

The sub-band re-scaling model 315 may confirm a signal processing path through which the second residual signal was generated, based on the flag information. For example, the sub-band re-scaling model 315 may confirm the signal processing path through which the second residual signal was generated, based on a bit value allocated to the flag information. When the bit value allocated to the flag information is “1,” the sub-band re-scaling model 315 may confirm that the second residual signal was generated through a first signal processing path. When the bit value allocated to the flag information is “0,” the sub-band re-scaling model 315 may confirm that the second residual signal was generated through a second signal processing path.

The sub-band re-scaling model 315 may select one of the plurality of signal restoration paths based on a type of signal processing path through which the second residual signal was generated. For example, the sub-band re-scaling model 315 may select a first signal restoration path when the second residual signal was generated through the first signal processing path. In addition, the sub-band re-scaling model 315 may select a second signal restoration path when the second residual signal was generated through the second signal processing path.

The first signal restoration path may be performed by the I-CTNS model 330. When the first signal restoration path is selected, the sub-band re-scaling model 315 may transmit (or send) the second residual signal to the I-CTNS model 330.

The I-CTNS model 330 may generate a first residual signal based on the second residual signal and the C-LPC bitstream. The I-CTNS model 330 may perform an inverse noise shaping operation on the second residual signal. The first residual signal may include a signal in which noise (e.g., noise in the time domain) is synthesized with the second residual signal through the inverse noise shaping operation. The I-CTNS model 330 may output the first residual signal to the I-FDNS model 335.

When the second signal restoration path is selected, the sub-band re-scaling model 315 may transmit (or send) the second residual signal to the I-FDNS model 335. In this case, the I-FDNS model 335 may perform subsequent operations using the second residual signal as the first residual signal.

The I-FDNS model 335 may obtain the first residual signal from the I-CTNS model 330 and/or the sub-band re-scaling model 315. For example, when the first residual signal is output through the first signal restoration path, the I-FDNS model 335 may obtain the first residual signal from the I-CTNS model 330. When the first residual signal is output through the second signal restoration path, the I-FDNS model 335 may obtain the first residual signal from the sub-band re-scaling model 315.

The I-FDNS model 335 may output a frequency-domain signal of an audio signal based on the LPC bit stream and the first residual signal. For example, the I-FDNS model 335 may generate the frequency-domain signal by performing I-FDNS on the first residual signal. The frequency-domain signal generated by the I-FDNS model 335 may include a signal including noise in the frequency domain. The I-FDNS model 335 may output the frequency-domain signal (e.g., a first residual signal on which I-FDNS has been performed) to the I-MCLT model 340.

The I-MCLT model 340 may convert the frequency-domain signal into a time-domain signal. For example, the I-MCLT model 340 may convert a frequency-domain signal into a time-domain signal through MCLT inverse transformation. The I-MCLT model 340 may output the time-domain signal to the TDA augment model 345.

The TDA augment model 345 may remove TDA of the audio signal based on the time-domain signal and the flag information. Based on the flag information, the TDA augment model 345 may determine a restoration signal path, among a plurality of restoration signal paths, through which the time-domain signal was generated. The TDA augment model 345 may remove TDA differently depending on the restored signal path through which the time-domain signal was generated.

Specifically, the TDA augment model 345 may remove TDA through Equation 6 below.

### [Equation 6]

$$y ( v ) = \{ \begin{matrix}{W}_{2} {y}_{c 2} ( v ) + {W}_{1} {\hat{y}}_{1} ( v + 1 ) \\ {W}_{2} {\hat{y}}_{2} ( v ) + {W}_{1} {y}_{c 1} ( v + 1 )\end{matrix} \qquad \begin{matrix}( 1 ) \\ ( 2 )\end{matrix}$$

In Equation 6, v denotes an index of a sub-band, y(v) denotes a time-domain signal of a v-th sub-band, yc1 denotes a time-domain signal processed through the first restoration signal path, yc2 denotes a time-domain signal processed through the second restoration signal path, w₁ denotes an N×N matrix corresponding to a left window function, and w₂ denotes an N×N matrix corresponding to a right window function.

The TDA augment model 345 may remove TDA through expression (1) of Equation 6 in the case of a time-domain signal processed through the first restoration signal path, and may remove TDA through expression (2) of Equation 6 in the case of a time-domain signal processed through the second restoration signal path.

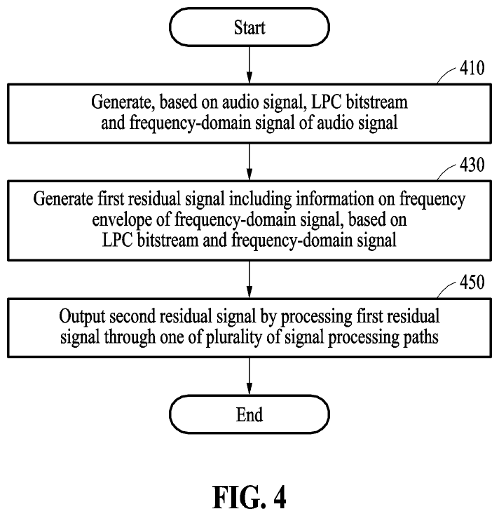

FIG. 4 is a flowchart of an encoding method according to an embodiment.

Referring to FIG. 4, operations 410 to 450 may be performed sequentially, but embodiments are not limited thereto. For example, two or more operations may be performed in parallel. Operations 410 to 450 may be substantially the same as the operations of the encoder (e.g., the encoder 110 of FIG. 1) described with reference to FIGS. 1 to 3. Accordingly, a detailed description thereof is omitted.

In operation 410, the encoder 110 may generate, based on an audio signal, an LPC bitstream and a frequency-domain signal of the audio signal. The audio signal may include a signal in a time domain.

In operation 430, the encoder 110 may generate a first residual signal including information on a frequency envelope of the frequency-domain signal, based on the LPC bitstream and the frequency-domain signal.

In operation 450, the encoder 110 may output a second residual signal by processing the first residual signal through one of a plurality of signal processing paths.

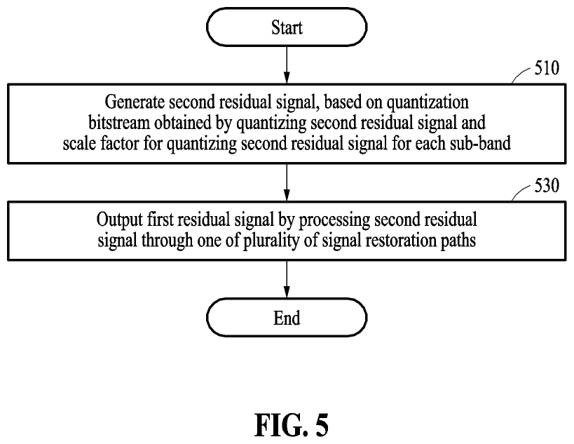

FIG. 5 is a flowchart of a decoding method according to an embodiment.

Referring to FIG. 5, operations 510 and 530 may be performed sequentially, but embodiments are not limited thereto. For example, two or more operations may be performed in parallel. Operations 510 and 530 may be substantially the same as the operations of the decoder (e.g., the decoder 130 of FIG. 1) described with reference to FIGS. 1 to 4. Accordingly, a detailed description thereof is omitted.

In operation 510, the decoder 130 may generate a second residual signal based on a quantization bitstream obtained by quantizing the second residual signal and a scale factor for quantizing the second residual signal for each sub-band.

In operation 530, the decoder 130 may output a first residual signal by processing the second residual signal through one of a plurality of signal restoration paths. For example, the decoder 130 may select one of the plurality of signal restoration paths based on flag information.

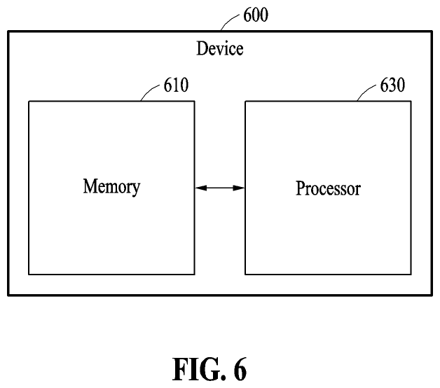

FIG. 6 is a diagram illustrating an example of a device, according to an embodiment. Referring to FIG. 6, a device 600 may include a memory 610 and a processor 630. The device 600 may include the encoder 110 of FIG. 1 or the decoder 130 of FIG. 1.

The memory 610 may store instructions (or programs) executable by the processor 630.

The memory 610 may be implemented as a volatile memory device or a non-volatile memory device.

The volatile memory device may be implemented as dynamic random-access memory (DRAM), static random-access memory (SRAM), thyristor RAM (T-RAM), zero capacitor RAM (Z-RAM), or twin transistor RAM (TTRAM).

The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase-change RAM (PRAM), resistive RAM (RRAM), nanotube RRAM, polymer RAM (PoRAM), nano floating gate memory (NFGM), holographic memory, a molecular electronic memory device, or insulator resistance change memory.

The processor 630 may process data stored in the memory 610. The processor 630 may execute computer-readable code (e.g., software) stored in the memory 610 and instructions triggered by the processor 630.

The processor 630 may be a hardware-implemented data processing device having a circuit that is physically structured to execute desired operations. The desired operations may include, for example, instructions or code included in a program.

The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The processor 630 may cause the device 600 to perform one or more operations by executing the instructions and/or code stored in the memory 610. Operations performed by the device 600 may be substantially the same as the operations performed by the encoder 110 and/or the decoder 130 described with reference to FIGS. 1 to 5. Accordingly, a repeated description thereof is omitted.

The components described in the embodiments may be implemented by hardware components including, for example, at least one digital signal processor (DSP), a processor, a controller, an ASIC, a programmable logic element, such as an FPGA, other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The examples described herein may be implemented using hardware components, software components, and/or combinations thereof. A processing device may be implemented using one or more general-purpose or special-purpose computers, such as, for example, a processor, a controller, an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is used as singular. However, one of ordinary skill in the art will appreciate that a processing device may include multiple processing elements and/or multiple types of processing elements. For example, a processing device may include a plurality of processors, or a single processor and a single controller. In addition, a different processing configuration is possible, such as one including parallel processors.

The software may include a computer program, a piece of code, an instruction, or some combination thereof, to independently or collectively instruct or configure the processing device to operate as desired. The software and/or data may be permanently or temporarily embodied in any type of machine, component, physical or virtual equipment, or computer storage medium or device for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The methods according to the above-described examples may be recorded in non-transitory computer-readable media including program instructions to implement various operations of the above-described examples. The media may also include the program instructions, data files, data structures, and the like alone or in combination. The program instructions recorded on the media may be those specially designed and constructed for the examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) and a digital versatile disc (DVD); magneto-optical media such as floptical disks; and hardware devices that are specially configured to store and perform program instructions, such as read-only memory (ROM), RAM, flash memory, and the like. Examples of program instructions include both machine code, such as those produced by a compiler, and files containing higher-level code that may be executed by the computer using an interpreter.

The above-described hardware devices may be configured to act as one or more software modules in order to perform the operations of the above-described examples, or vice versa.

Although the examples have been described with reference to the limited number of drawings, it will be apparent to one of ordinary skill in the art that various technical modifications and variations may be made in the examples without departing from the spirit and scope of the claims and their equivalents. For example, suitable results may be achieved if the described techniques are performed in a different order, and/or if components in a described system, architecture, device, or circuit are combined in a different manner and/or replaced or supplemented by other components or their equivalents.

Therefore, other implementations, other examples, and equivalents to the claims are also within the scope of the following claims.

What is claimed is:

1. A method of encoding an audio signal, the method comprising:
generating, based on the audio signal, a linear prediction coding (LPC) bitstream and a frequency-domain signal of the audio signal;
generating, based on the LPC bitstream and the frequency-domain signal, a first residual signal comprising information on a frequency envelope of the frequency-domain signal; and
outputting a second residual signal by processing a first residual signal through one of a plurality of signal processing paths,
wherein the plurality of signal processing paths comprises:
a first signal processing path that comprises a noise shaping operation; and
a second signal processing path that does not comprise the noise shaping operation.

2. The method of claim 1, wherein the outputting of the second residual signal comprises:
selecting one of the plurality of signal processing paths based on a prediction gain of the first residual signal.

3. The method of claim 2, wherein the selecting of one of the plurality of signal processing paths comprises:
selecting the first signal processing path when the prediction gain of the first residual signal is greater than or equal to a preset threshold value; and
selecting the second signal processing path when the prediction gain of the first residual signal is less than the preset threshold value.

4. The method of claim 3, wherein the outputting of the second residual signal further comprises:
outputting flag information indicating whether the noise shaping operation has been performed, based on a type of a signal processing path, among the plurality of signal processing paths, through which the first residual signal is processed.

5. The method of claim 4, wherein the first signal processing path is a path through which to:
output a complex-LPC (C-LPC) bitstream based on the first residual signal, and
output a signal, which is obtained by removing noise from the first residual signal through the noise shaping operation, as the second residual signal, based on the C-LPC bitstream.

6. The method of claim 5, wherein the second signal processing path is a path through which to output a real part of the first residual signal as the second residual signal.

7. The method of claim 1, wherein the outputting of the second residual signal further comprises:
outputting a scale factor for quantizing the second residual signal for each sub-band; and
outputting, based on the scale factor and the second residual signal, a quantization bitstream obtained by quantizing the second residual signal.

8. A method of decoding an audio signal, the method comprising:
generating a second residual signal based on a quantization bitstream obtained by quantizing the second residual signal and a scale factor for quantizing the second residual signal for each sub-band; and
outputting a first residual signal by processing the second residual signal through one of a plurality of signal restoration paths,
wherein the plurality of signal restoration paths comprises:
a first signal restoration path that comprises an inverse noise shaping operation; and
a second signal restoration path that does not comprise the inverse noise shaping operation.

9. The method of claim 8, wherein the outputting of the first residual signal comprises:
selecting one of the plurality of signal restoration paths based on flag information that indicates whether a noise shaping operation has been performed.

10. The method of claim 9, wherein the outputting of the first residual signal comprises:
when the first signal restoration path is selected, outputting a signal, in which noise is synthesized with the second residual signal through the inverse noise shaping operation, as a first residual signal, based on the second residual signal and a complex linear prediction coding (LPC) bitstream.

11. The method of claim 9, wherein the outputting of the first residual signal comprises:
when the second signal restoration path is selected, outputting the second residual signal as the first residual signal.

12. The method of claim 10, wherein the outputting of the first residual signal further comprises:
restoring the audio signal based on an LPC bitstream and the first residual signal.

13. The method of claim 12, wherein the restoring of the audio signal comprises:
outputting a frequency-domain signal of the audio signal based on the LPC bitstream and the first residual signal; and
outputting a time-domain signal of the audio signal based on the frequency-domain signal and the flag information.

14. The method of claim 13, wherein the outputting of the time-domain signal of the audio signal comprises:
removing time-domain aliasing (TDA) of the audio signal based on the frequency-domain signal and the flag information.

15. A device for encoding an audio signal, the device comprising:
a processor; and
a memory configured to store instructions,
wherein the instructions, when executed by the processor, cause the device to:
generate, based on the audio signal, a linear prediction coding (LPC) bitstream and a frequency-domain signal of the audio signal;
generate, based on the LPC bitstream and the frequency-domain signal, a first residual signal comprising information on a frequency envelope of the frequency-domain signal; and
output a second residual signal by processing the first residual signal through one of a plurality of signal processing paths,
wherein the plurality of signal processing paths comprises:
a first signal processing path that comprises a noise shaping operation; and
a second signal processing path that does not comprise the noise shaping operation.

16. The device of claim 15, wherein the instructions, when executed by the processor, cause the device to:
select one of the plurality of signal processing paths based on a prediction gain of the first residual signal.

17. The device of claim 16, wherein the instructions, when executed by the processor, cause the device to:
output flag information indicating whether the noise shaping operation has been performed, based on a type of a signal processing path, among the plurality of signal processing paths, through which the first residual signal is processed.

18. The device of claim 17, wherein the first signal processing path is a path through which to:
output a complex-LPC (C-LPC) bitstream based on the first residual signal, and
output a signal, which is obtained by removing noise from the first residual signal through the noise shaping operation, as the second residual signal, based on the C-LPC bitstream.

19. The device of claim 18, wherein the second signal processing path is a path through which to output a real part of the first residual signal as the second residual signal.

20. The device of claim 19, wherein the instructions, when executed by the processor, cause the device to:
output a scale factor for quantizing the second residual signal for each sub-band; and
output, based on the scale factor and the second residual signal, a quantization bitstream obtained by quantizing the second residual signal.
